(19) United States
(12) Patent Application Publication
(10) Pub. No.: US 2020/0396977 A1
(43) Pub. Date: Dec. 24, 2020

(54) CAGE FOR CAPTURING HYMENOPTERA

(71) Applicant: JABEPRODE, PENCRAN (FR)

(72) Inventor: Denis JAFFRE, Locmélar (FR)

(73) Assignee: JABEPRODE, PENCRAN (FR)

(21) Appl. No.: 16/971,983

(22) PCT Filed: Feb. 22, 2019
(86) PCT No.: PCT/IB2019/051453

§ 371 Date: Aug. 21, 2020

(30) Foreign Application Priority Data
Feb. 22, 2018 (FR) 18/51532

(51) Int. Cl. A01M 1/10; A01M 1/02; A01M 23/08

(52) U.S. Cl. CPC A01M 1/106; A01M 23/08; A01M 1/02

(57) ABSTRACT

The invention concerns a selective capture cage (20) for hymenoptera comprising a box having a bottom (201) and at least three walls, at least two walls of which each have an opening for the circulation (22) of scents, each circulation opening (22) of scents comprises a porous plate (21) covering the circulation opening (22) of scents, said porous plate (21) comprises a funnel section having a large base and a small base, the small base comprises at least one selective passage opening (212) and the small base is placed towards the inside of the capture cage (20), characterized in that:
the passage opening (212) comprises at least a limiting passage section is comprised between 7.0 and 9.0 mm, preferably 7.21 mm; and
in that the limiting section for passage of the pores of the porous plate (21) is smaller in size than the passage opening (212).

### TECHNICAL FIELD OF THE INVENTION

The present invention concerns an autonomous capture cage for undesirable insects, this model concerns the species Vespa velutina, a hymenoptera more commonly called Asian hornet or yellow-legged hornets.

### STATE OF THE ART

The Asian hornet, accidentally imported with Chinese goods in 2004, turns out to be a very pervasive pest due to its exponential mode of reproduction and its needs in meat proteins.

Generalist predator, it impacts many species of useful insects including many pollinators which are prey to this predator, it is in fact destructive of biodiversity and threatens the food chain by its omnipresence on territories with large density fluctuations.

This hornet is capable of destroying entire apiaries of honeybees in a single season, severely hampering beekeeping activity and accelerating the disappearance of beekeepers by ruining their farms.

Asian hornets are social insects and therefore live in colonies. They shelter in cellulose nests and are made up of individuals divided into castes, each playing a defined role in the colony. The queen founds the colony then lays eggs. The workers, female workers, unfertilized, remove the larvae, provide the colony with food and build the nest. The young queens ensure the dissemination of the species over a radius of nearly 70 km/year (source Institute for Research on the Biology of the Insect of Tours). The social bond is ensured by a pheromone produced by the founder which is specific to each colony (nest). The phenomenon of “trophallaxis”, less developed in Vespa velutina than in the honeybee allows the sharing and the exchange of the food brought back to the nest by the workers between all the individuals of the colony. The young queen, become “founder” is at the centre of the social network of the colony through her production of pheromones allowing its perfect cohesion. The founder having a major role in reproduction, her death eventually leads to the decline of the colony.

All females of social hymenoptera are provided with a harmful system, that is to say a sting capable of injecting venom, which is painful and sometimes dangerous for humans if the envenomation is great.

From a biological point of view, Vespa velutina distinguishes itself from its European cousin Vespa crabro by several traits, morphological nuances and its exclusively diurnal activity.

The nest of Vespa velutina is generally built in the open air, very often on the top of large trees, unlike its European cousin which establishes its nest always in pre-existing cavities, well sheltered from bad weather.

Vespa velutina lives better in an anthropized environment than in the countryside. Its nest is also much more voluminous and populous: it can contain up to 2000 individuals vs. 800 for Vespa crabro.

Vespa velutina is particularly efficient in hunting because, very fast and able to hover. This allows it to capture its prey very effectively. It takes them to cut them and keep only the thorax with which it will make a dumpling which it brings back to the nest to feed the larvae.

When an Asian hornet's nest has detected an apiary or a nest of social insects, the presence of hornets hovering in front of the entrance to the hives stresses the colonies of bees which then no longer feed normally: the reserves run out, the queens stop laying and the colonies collapse due to the lack of food and/or population to maintain a sufficient temperature in the colony.

The Asian hornet is therefore a scourge for beekeeping activity.

There is a control technique that can destroy an undiscovered nest by capturing the insect and then handling it and depositing an attractive insecticide product. When it returns to the nest, it infects other hornets (in principle of the “Trojan horse”). To be implemented, a good control is required (because it is necessary to handle them).

Trapping consists in the use of devices which contain an attractive bait for the hornets, and which keep them captive.

The vast majority of traps, of the “bottle or bell” type, are not effective enough because the hornet can perform vertical flights making their escape possible and have the major drawback of being insufficiently selective.

By way of illustration US2018/0042212 discloses an insect trap using a bottle and a funnel system which on the one hand lacks selectivity and which on the other hand does not allow sufficient diffusion of the olfactory scent of a possible bait. A similar principle is found in U.S. Pat. No. 1,386,408 which suffers from the same defects (admittedly attenuated). US869556 and WO 2012/001442 disclose cages which do not allow species selectivity. All these traps do not allow a satisfactory capture of Vespa velutina.

Another curative control technique consists in destroying the nests by means of important equipment (telescopic pole, spraying equipment), and good protections, manipulation of biocides and possible attack of hornets. The electrocution of the hornets by an “electric harp” allows the destruction of the hornets near the hives. All of these methods are curative and do not effectively regulate the species.

### OBJECT OF THE INVENTION

The present invention aims to remedy all these drawbacks.

To this end, the present invention relates to a selective capture cage (20) for hymenoptera comprising a box having a bottom (201) and at least three walls (for example four walls) of which at least two walls each comprise an opening for the circulation (22) of scents, each opening (22) for the circulation of scents comprises a porous plate (21) covering the opening (22) for the circulation of scents, said porous plate (21) comprises a funnel section having a large base and a small base, the small base comprises at least one selective passage opening (212) and the small base is placed towards the inside of the capture cage (20), characterized in that:
the passage opening (212) comprises at least one limiting passage section with a dimension comprised between 7.0 and 9.0 mm, preferably 7.21 mm; and
in that the pores limiting section of passage of the porous plate (21) is smaller in size than the passage opening (212).

In the context of the present invention, by “funnel”, it is understood a trap system, or equivalent (e.g. in the form of a funnel for pouring a liquid), making it possible to channel the insects towards the entry (passage opening) into the capture cage. It can therefore in theory be of any form as long as it fulfils this function. Preferably, the funnel of the invention is of generally frustoconical shape, for example of circular, oval or polygonal section such as a triangle, a square, a rectangle, a rhombus, a pentagon, a hexagon, a heptagon or an octagon.

Preferably, the passage opening (212) comprises at least one limiting passage section of a dimension greater than 7.0 mm and less than 8.7 mm, preferably less than 8.5 mm, more preferably less than 8.0 mm, even more preferably less than 7.5 mm, for example less than 7.23 mm.

More preferably, the passage opening (212) comprises at least one limiting passage section of a dimension comprised between 7.1 and 8.0 mm, preferably comprised between 7.15 and 7.5 mm, more preferably comprised between 7.17 mm and 7.30 mm, even more preferably comprised between 7.18 mm and 7.25 mm, for example comprised between 7.19 mm and 7.23 mm, such as comprised between 7.20 mm and 7.22 mm.

Preferably, the funnel section has the shape of a pyramid trunk (213).

Preferably, the capture cage according to the present invention is characterized in that the limiting section for passage of the pores is of a size less than or equal to 12 mm, less than or equal to 11 mm, less than or equal to 7 mm, or less than or equal to 5 mm.

Advantageously, the capture cage according to the present invention is characterized in that the pores of the porous plate (21) comprise a polygonal shape and/or a rounded shape. Thus, the polygonal shape can be a rhombus, for example with a long diagonal comprised between 14 and 18 mm and a short diagonal comprised between 5 and 9 mm. In a particular embodiment, the rounded shape consists of a rectangle of which at least one corner is rounded, or even characterized in that at least one side of the rectangle is completely rounded.

In addition, the present invention concerns a capture cage for hymenoptera comprising a box having a bottom and four walls, two walls of which each comprise an opening for the circulation of scents, remarkable in that each aperture for circulating scents comprises a porous plate (such as a screen plate). Said porous plate (such as a screen plate) can cover the opening for the circulation of scents, and can be constituted of at least one portion of screen having meshes whose vertical height is less than 0.7 cm. Said porous plate (such as a screen plate) may comprise a funnel in the shape of a pyramid trunk having a large base and a small base directed towards the inside of the capture cage, said pyramid trunk having a passage opening corresponding to the small base of the pyramid trunk.

Thanks to these provisions, little is necessary as know-how and as material. The passage opening will allow all the Asian hornets to enter while preventing them from coming out because the funnel (e.g. the trunk of the pyramid) directed inwards prevents the hornet(s) from finding the exit. The cage makes it possible to carry out an effective preventive fight.

Installing this type of device in the apiary (or elsewhere) will allow the bees to exit the capture cage while retaining only the Asian hornets. The mesh size of the porous plate (such as a screen plate) allows bees and other small insects to exit.

Thus, advantageously, the capture cage according to the present invention is characterized in that the hymenoptera is the species Vespa velutina, and preferably the capture cage is configured to not retain honeybees.

The invention is advantageously implemented according to the embodiments and the variants set out below, which are to be considered individually or according to any technically operative combination.

In one embodiment, the screen has meshes whose long diagonal is comprised between 14 and 18 mm, the short diagonal is comprised between 5 and 9 mm, the strap is comprised between 0.8 and 1.2 mm and the thickness is comprised between 0.6 and 1 mm.

In one embodiment, the passage opening (212) has the shape of a rectangle whose length is comprised between 10 to 30 mm, such as 20 mm, and whose width is comprised between 7.0 and 9.0 mm, such as 7.21 mm. Thus, the capture cage according to the present invention can be characterized in that the cage is configured so that the length is horizontal to the ground and the width is perpendicular to the ground.

Preferably, the capture cage (20) according to the present invention is characterized by the distance between the large base and the small base of the funnel comprised between 10 to 15 cm. In a particular embodiment, the height between the large base and the small base of the pyramid trunk can be comprised between 10 to 15 cm.

In one embodiment, the box comprises a removable cover (having the property of insulating the interior from the exterior at its level).

In one embodiment, the two walls each comprise an opening in vis-à-vis.

In one embodiment, the bottom comprises at least one porous portion (such as a mesh part) under which it is intended to position a bait.

In one embodiment, the porous plate (such as a screen plate) comprises a flat rectangular portion whose length is comprised between 11 and 20 cm and the width is comprised between 7 and 15 cm.

In addition, the object of the present invention concerns a funnel for a capture cage (20) as described herein, said funnel ending on its finest side by a base having at least one selective opening (212), characterized in that the passage opening (212) comprises at least one limiting passage section comprised between 7.0 and 9.0 mm, preferably 7.21 mm.
Thus, preferably, the funnel according to the present invention can be characterized in that the passage opening (212) has the shape of a rectangle whose length is comprised between 10 and 30 mm, such as 20 mm, and the width is comprised between 7.0 and 9.0 mm, such as 7.21 mm.

In a particular embodiment, the funnel according to the present invention can be characterized in that it comprises a porous portion whose limiting section for passage of the pores is smaller in size than the limiting section for passage of the passage opening (212).

Thus, one of the objects according to the present invention concerns a funnel as described herein, characterized in that said funnel has the shape of a trunk of a pyramid (213).
In addition, an object of the present invention concerns a kit for manufacturing a funnel as described above, characterized in that said kit comprises:
a base with a passage opening (212) as defined herein,
at least three triangular pieces, preferably four triangular pieces, said triangular pieces being truncated at one of their ends,
at least one means for fixing said base with said at least three triangular parts at their truncated end.

Furthermore, an object of the present invention concerns a kit for a capture cage (20) according to the present invention, characterized in that said kit comprises
a box having a bottom (201),
at least three walls, preferably four walls, at least two walls of which each comprise an opening for attaching a funnel as described above,
a funnel as described above, and
a lid.

Another object of the present invention concerns the use of a capture cage (20) according to the present invention for capturing at least one hornet, preferably a hornet of the species Vespa velutina (capture of queens: preventive use, and/or capture of workers: curative use). This use can be characterized in that at least one bait is inserted into the capture cage (20), said at least one bait being optionally positioned and protected under a porous part, such as a screened part. In this embodiment, the use can be characterized in that said at least one bait is selected in the list consisting of honeyed waxes, red fruit syrup, dark beer, cider or sweet white wine saturated in sugars to which jam and/or honey may be added, or of meaty material, for example from fish, crustaceans or shellfish, or one of the mixtures thereof.

The present invention may also concern the use as described herein, characterized in that islets made up of small sponges are inserted as diffusers of olfactory scents in the capture cage (20).

### BRIEF DESCRIPTION OF THE FIGURES

Other advantages, aims and characteristics of the present invention emerge from the description which follows, given for explanatory purposes and in no way limiting, in regard to the appended drawings, in which:

FIG. 1 represents a perspective view of the interior of the capture cage of a particular embodiment of the cage, object of the present invention,

FIG. 2 represents a perspective view from one side only of the capture cage of FIG. 1, object of the present invention,

FIG. 3 represents a perspective view of a porous plate (such as a screen plate),

FIG. 4 represents a mesh of the porous plate (such as a screen plate),

FIG. 5 represents the elements of a kit for a pyramid-shaped funnel according to the present invention.

FIG. 6 is a photograph of the result of one of the tests carried out, as explained below.

### DESCRIPTION OF EXAMPLES OF EMBODIMENT OF THE INVENTION

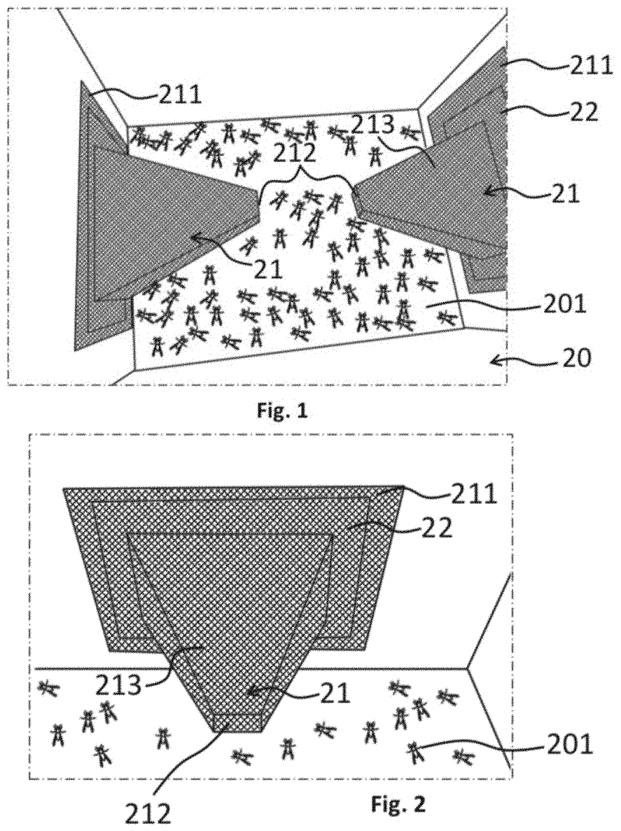

FIG. 1 represents a perspective view of the interior of the capture cage 20.

FIG. 2 represents a perspective view from one side of the capture cage 20.

In these figures is shown a box having a bottom 201 and four walls, two walls of which comprise an opening 22 for the circulation of scents.

Each opening 22 for the circulation of scents is covered by a porous plate (such as a screen plate) 21 entirely covering the opening 22 for the circulation of scents.

The porous plate (such as a screen plate) 21 is constituted of a screen having meshes whose long diagonal is 16 mm, the short diagonal is 8 mm, the strap is 1 mm and the thickness is 0.8 mm.

The porous plate (such as a screen plate) 21 comprises a funnel in the shape of a pyramid trunk 213 having a large base and a small base directed towards the inside of the capture cage 20, said pyramid trunk 213 having a passage opening 212 corresponding to the small base of the pyramid trunk 213.

The funnel can be made of any material sufficiently rigid for its implementation, for example metal, organic polymer such as plastic (e.g. PVC) or a biological material such as wood or reconstituted cellulose. Shown here is a funnel shaped like a trunk of pyramid 213 made of expanded metal. In one example, the funnel is thus in metal, such as aluminium. According to other examples, it is made of other materials which make it possible to maintain the shape of the funnel (such as a trunk of pyramid 213). The dimension of the expanded metal can be 16×8×1×0.8 mm and it is fixed on a porous plate (such as a screen plate) 21 of the same nature.

The profile of rigid material (such as metal) deployed in the chosen format, allows the passage of bees and other insects of equivalent or smaller size through the pores/meshes (in both directions) in the best conditions of ease and of speed.

The porous plate (such as a screen plate) 21 is positioned to the normal of the longitudinal axis of the funnel and allows the circulation of scents and a rapid exit of the bees without cluttering. The porous plate (such as a screen plate) 21 comprises a flat portion 211 of rectangular shape whose length is comprised between 11 and 20 cm, for example 15 cm and the width is comprised between 7 and 15 cm, for example 10 cm.

The porous plate (such as a screen plate) 21 is arranged like this: the base of the rhombus of the meshes is directed towards the outside for more ease of exit than re-entry. The fixing of the funnel on the porous plate (such as a screen plate) 21 is done, after a cut of 10×20 cm in a screen plate. The fixing is carried out by stapling, pointing, screwing (e.g. on wood, photo), by gluing (resin adhesive for plastic) or by nylon collar on the capture cage 20 and by a covering of about 1 cm.

The passage opening 212 of the funnel (such as a pyramid trunk) 213 porous/meshed, directed inward, allows the easy passage of the Asian hornet queens and, for this purpose, has a calibrated opening of 7.21 mm high for the effective passage of the thorax of an Asian hornet queen while prohibiting that of a European hornet queen which is about 1.5 mm larger in size. This is why it is possible to have an opening in a range of values around 7.21 mm in order to vary the selectivity of the cage.

The depth of the funnel (such as a pyramid trunk) of the module and its fully ventilated structure is long enough to prevent the Asian hornet from finding the exit (principle of the trap). Experiments have shown that no Asian hornet entered has ever emerged.

The height (or depth of the funnel) between the greater base and the smaller base of the funnel (such as a pyramid trunk) 213 is 13 cm (comprised between 10 and 15 cm).

The capture cage 20 preferably comprises two funnels, facing each other for an optimisation of the circulation of scents.

In another example, the two funnels are not facing each other, but for space reasons, the longitudinal axis of the two funnels is offset from one another.

The wide opening of the funnel thus ensures the reception and capture of all the Asian hornet queens from the environment of the capture cage 20 over very long distances to the point of no longer risking predation by worker hunters throughout the season to protect an apiary.

The Capture Cage 20 Contains a Bait.

In one example, the bait is positioned under the bottom 201 of the capture cage 20. The bottom 201 of the capture cage 20 comprises a mesh portion under which is positioned a bait. The assembly constituted of the capture cage 20 and of the bait allow the capture of the Asian hornet.

In another variant, the bait is positioned inside the cage always with a grid to let the olfactory odours be released.

The bait which has shown the best effectiveness is constituted of honeyed waxes (opercula for harvests or honey frames) which must imperatively be protected by a fine screen (of the fine stainless-steel mesh type used for aeration of hive floors) to prevent access to all insects. There are two reasons for this:
the need for non-target insects to quickly exit the capture cage 20 (because they cannot access the bait) and to prevent them from becoming prey to the Asian hornets already present in the capture cage 20; and/or
the potential risk of transmission of pathologies by the contamination of bees by American foulbrood spores which could be present in the honeyed waxes (or bayberry juice). To further limit the predation of bees by Asian hornets already caught, it is possible to bring (in season and for curative operation) into the capture cage 20 some meaty material from raw unprotected fish remains (to be replaced every two/three days). This allows the flies to be present in the capture cage 20, the latter then becoming the preferred prey of the Asian hornet instead of the bees which are no longer stationery and only circulate in the capture cage 20, thus becoming less easily preys. Pieces of oily fish (such as leftovers), crustaceans and shellfish are meat substances highly prized by Asian hornets to feed their offspring.

For those who do not have honeyed waxes, it can be used a mixture of red fruit syrup, dark beer, cider saturated in sugars to which it can be added jam or honey (for example from leftover jam or jars of honey forgotten at the bottom of a cupboard). Islets made up of small sponges are all diffusers of complementary scent. It may be recalled that it is only the fragrant scents that exhale baits, and which will attract Asian hornets. The larger the area of the bait, the more effective and larger the range of action the capture cage 20 has. The very strong attractiveness which makes it possible to collect over a very wide radius is linked to a particularly effective bait which can be of several types, placed on a very large surface inaccessible to all insects. This allows a quick death of hornets, respect for the health aspect of bees (avoid the transmission of diseases by American foulbrood spores) allowing them to come out very quickly as well as all other small insects.

The imperative period is spring to prevent the construction of Asian hornet nests. It allows the capture of queens from the end of March. Given the capture of all the queens, to not take into account the intra-specific competition (fight of the queens between them) that they do from this period for the usurpation of the nests. From the end of June, the capture of queens is rarer, or even stops.

For beekeepers, the presence of a capture cage 20 near the apiary is indispensable from March to November (or simply, up to the end of the capture of the queens). Its selective nature allows this. A capture cage 20 installed routinely, each year, on either side of the apiary protects it during the entire period of activity of the bees.

From the beginning of spring, it is absolutely necessary to remove from the apiary any dead or weak hive that would compete with the capture cage 20 for the honey it contains (and also imperative in terms of general health).

For the beekeeper, the capture cage 20 allows the use of a crystallized honey frame constituted of two superimposed rises (if you have rising honey frames). The first rise will contain the honey frames, it is placed on a bottom 201 of ventilated hive closed by an entrance door fitted on the closing side to prevent any passage of insect. This rise is isolated from that at the top by the fine screen described above to protect the bait (the best) from the size of the rise or from a propolis grid kept away from the heads of frames by wedging. The top (empty) rise becomes the capture cage 20 of the Asian hornet and is protected by a removable cover. The removable cover has for function to close the box and functions like a roof whose dimensions are greater than the section of the box (i.e. insulation). If hive body frames are available, the bottom rise is replaced by a hive body.

An alternative: above, instead of a rise, so as not to condemn beekeeping equipment, a simple wooden frame made by assembling 4 boards on which is fixed the two screen plates with each their funnel.

How to Eliminate Asian Hornets Once in the Capture Cage 20?

At nightfall, the captured Asian hornets, present in the capture cage 20 are generally grouped on a social hymenopterous wall. Asian hornets to be destroyed can be collected in a jar with a small tool (brush . . . or with a cordless vacuum cleaner). Freezing or crushing them is one of the solutions for their elimination.

Placement of a capture cage 20 is also very important in the event of attacks of apiaries, in summer and autumn, Asian hornets enter it in large quantities.

The spring selective capture of all the Asian hornet queens in a sector remains, to this day, the only simple and inexpensive preventive control method which gives real results in terms of regulation of the Invasive Exotic Species (IAS) Vespa velutina nigrithorax

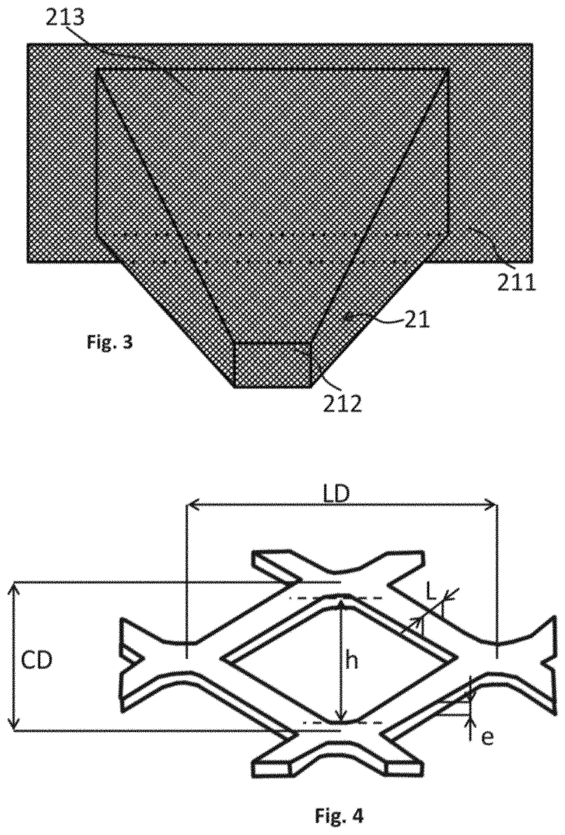

FIG. 3 represents a porous plate (such as a screen plate) 21 comprising a funnel in the form of a trunk of pyramid 213 having a large base and a small base. The pyramid trunk 213 is directed towards the inside of the capture cage 20. The pyramid trunk 213 has a passage opening 212 corresponding to the small base of the pyramid trunk 213.

FIG. 4 represents a mesh of the screen of the plate.

According to an example, the grid is made of expanded metal. The metal is for example aluminium.

The expanded metal is made from metal sheets, by cutting and cold drawing. It presents very resistant mesh stretched in a single operation.

This figure shows the characteristics of the plate mesh: LD for long diagonal, CD for short diagonal, L for strap and e for thickness.

The porous plate (such as a screen plate) is constituted of a screen having meshes whose long diagonal is 16 mm, the short diagonal is 8 mm, the strap is 1 mm and the thickness is 0.8 mm.

The short diagonal is measured between two mesh axes as shown in the figure.

To prevent the Asian hornet from going out, on the axis of the short diagonal, the empty space, noted h, corresponding to the height of the mesh is less than 0.7 cm.

FIG. 5 represents the elements of a kit for a funnel in the shape of a pyramid trunk according to the present invention, particularly well suited to the capture of Vespa velutina. In the context of the present invention, it has been found that the size of the thorax of the Asian hornet queens Vespa velutina is very slightly less than the size of the thorax of the European hornet queens Vespa crabro. It is thus possible to be selective in this regard

Thus, this kit may comprise a base with a passage opening (212) of rectangular shape with a width of 7.21 mm (i.e. a limiting passage section of 7.21 mm) and a length of 20 mm. Truncated triangular pieces linked to each other by attachment means (I), make it possible to define a funnel. The attachment means can be of the male or female type as represented, making it possible to attach one (e.g. by clips) to each other. The triangular piece may comprise male and/or female attachment means. The funnel can be inserted into a box to form a cage according to the present invention by means of attachment (K). The box may comprise a means of attachment complementary to the attachment (K), for example by similar operation to the attachment (I). These truncated triangular pieces comprise a means of fixing the base, such as a notch (E). The base here is generally rectangular in shape, but can also be of another shape (triangular, pentagonal, hexagonal, etc.) depending on the number of truncated triangular pieces surrounding it. Preferably, the base is generally rectangular in shape, and requires 4 truncated triangular pieces to form the funnel (pyramidal trunk). The pores of the porous plate are here rectangles with rounded corners (here a whole side is rounded), the length of which is 11 mm and the width of 5 mm. Indeed, it has been found that the exit of small insects is facilitated by such patterns (internal side draft on the porous plate and the cone with the edges of the rounded openings).

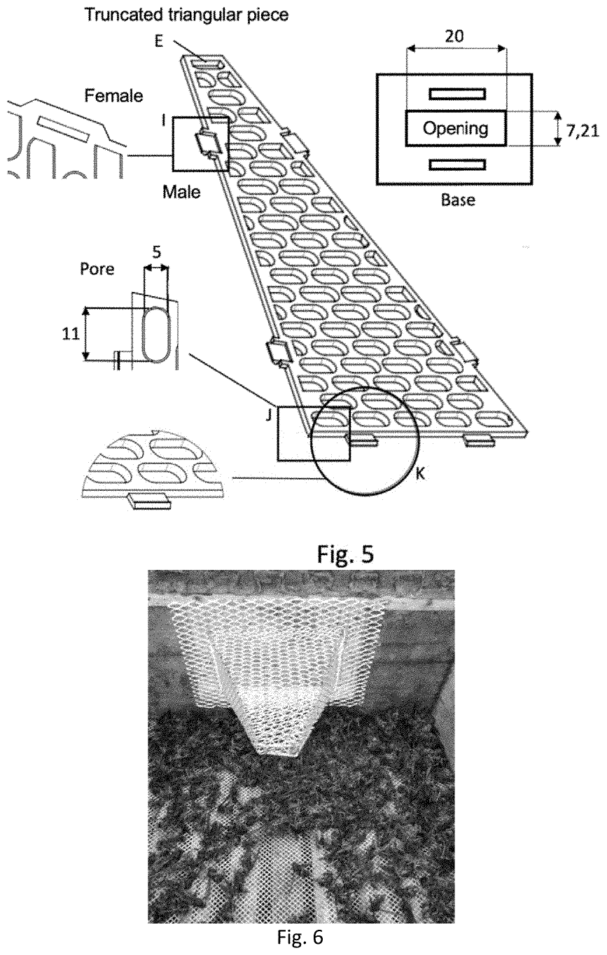

In the context of the present invention a calibration to the hundredth of a millimetre (mm) was carried out for the passage opening with tests carried out on 9 Vespa velutina queens to check a uniformity of the height of their thorax. In practice for 6 months (from mid-May 2017 to November 2017), two cages according to the present invention (one of which was photographed in FIG. 6) put in place made it possible to capture hornets Vespa velutina in a curative way (i.e. not queens). The passage openings were identical: rectangular with a length of 20 mm and a width of 7.21 mm. The cages were configured so that the length axis (20 mm) of the openings was horizontal, and the width axis (7.21 mm) was vertical. The two traps were placed in the same apiary of honeybees: one of them laid on a hive and the other at a distance. The type of bait used in the traps was honey-based (in the form of honeycomb wax lids from honey extractions for boxes—possibility of using honey frames for hives). 1062 Asian hornets (the equivalent of half a hive of these hornets) were thus captured with an observed selectivity of 99.7%. In fact, a single wasp queen and two first generation European hornet workers were caught in addition to the Vespa velutina hornets. The two workers of European hornet type (normally larger than Asian hornets) were accidentally retained (this due to their specific size reduced compared to normal). However, such a proportion of catch (0.2%) remains acceptable, even negligible, compared to the number of Vespa velutina hornets captured by the cage according to the present invention.

The same devices were installed in March 2018 for the whole of the following year: around twenty queens were quickly captured and a few workers thereafter, but much less than the previous year, demonstrating that a preventive use focused on capturing queens is in early spring.

### Clauses

One aspect of the present invention concerns and is summarized in the clauses below:

Clause 1. Hymenoptera capture cage (20) comprising a box having a bottom (201) and four walls, two walls of which each comprise an opening for the circulation (22) of scents, characterized in that each circulation opening (22) of scents comprises a screen plate (21) covering the circulation opening (22) of scents, said screen plate (21) is constituted of at least one portion of screen having meshes whose vertical height is less than 0.7 cm (for example equal to or less than 0.5 cm) said screen plate (21) comprises a funnel in the shape of a pyramid trunk (213) having a large base and a small base directed towards the inside of the capture cage (20), said pyramid trunk (213) having a passage opening (212) corresponding to the small base of the pyramid trunk (213).

Clause 2. Capture cage (20) according to clause 1, in which the screen has meshes whose long diagonal is comprised between 14 and 18 mm, the short diagonal is comprised between 5 and 9 mm, the strap is comprised between 0.8 and 1.2 mm and the thickness is comprised between 0.6 and 1 mm.

Clause 3. Capture cage (20) according to clause 1, wherein the passage opening (212) is a rectangle whose width is comprised between 1 to 3 cm and the height is comprised between 0.7 and 0.9 cm.

Clause 4. Capture cage (20) according to clause 1, wherein the height between the large base and the small base of the pyramid trunk (213) is comprised between 10 to 15 cm.

Clause 5. Capture cage (20) according to clause 1, wherein the box comprises a removable insulating cover.

Clause 6. Capture cage (20) according to clause 1, wherein the two walls each comprise an opening in vis-à-vis.

Clause 7. Capture cage (20) according to claim 1, wherein the bottom (201) comprises at least one mesh portion under which it is intended to position a bait.

Clause 8. Capture cage (20) according to clause 1, wherein the screen plate (21) comprises a flat portion (211) of rectangular shape whose length is comprised between 11 and 20 cm and the width is comprised between 7 and 15 cm.

### NOMENCLATURE

20 Capture cage
   201 bottom
21 porous plate (such as a screen plate)
   211 flat portion of the porous plate (such as a screen plate)
   212 passage opening
   213 pyramid trunk
22 circulation opening of scents

1-29. (canceled)

30. Selective hymenoptera capture cage comprising a box having a bottom and at least three walls, at least two walls of which each comprise an opening for the circulation of scents, each circulation opening of scents comprises a porous plate covering the circulation opening of scents, said porous plate comprises a funnel section having a large base and a small base, the small base comprises at least one selective passage opening and the small base is placed towards the inside of the capture cage, wherein:
the passage opening comprises at least a limiting passage section comprised between 7.0 and 9.0 mm, preferably 7.21 mm; and
in that the limiting section for passage of the pores of the porous plate is smaller in size than the passage opening.

31. Hymenoptera capture cage according to claim 30, wherein the funnel section has the shape of a pyramid trunk.

32. Hymenoptera capture cage according to claim 30, wherein the cage comprises four walls.

33. Hymenoptera capture cage according to claim 30, wherein the hymenoptera is the species Vespa velutina, and preferably the capture cage is configured so as not to retain domestic or honeybees.

34. Hymenoptera capture cage according to claim 30, wherein limiting pore passage section is less than or equal to 12 mm, less than or equal to 11 mm, less than or equal to 7 mm, or less than or equal to 5 mm.

35. Hymenoptera capture cage according to claim 30, wherein the pores of the porous plate comprise a polygonal shape and/or a rounded shape.

36. Hymenoptera capture cage according to claim 35, wherein the polygonal shape is a rhombus, for example with a long diagonal comprised between 14 and 18 mm and a short diagonal comprised between 5 and 9 mm.

37. Hymenoptera capture cage according to claim 35, wherein the rounded shape is constituted of a rectangle of which at least one corner is rounded.

38. Hymenoptera capture cage according to claim 37, wherein at least one side of the rectangle is completely rounded.

39. Hymenoptera capture cage according to claim 30, wherein the passage opening has the shape of a rectangle whose length is comprised between 10 and 30 mm, such as 20 mm, and the width is comprised between 7.0 and 9.0 mm, such as 7.21 mm.

40. Hymenoptera capture cage according to claim 39, wherein the passage opening is calibrated for the effective passage of the thorax of a hornet queen Vespa velutina whilst preventing the passage of a hornet queen Vespa crabro.

41. Hymenoptera capture cage according to claim 39, wherein the cage is configured so that the length is horizontal to the ground and the width is perpendicular to the ground.

42. Hymenoptera capture cage according to claim 30, wherein the porous plate is a screen plate.

43. Hymenoptera capture cage according to claim 42, wherein the screen of the screen plate has meshes with a strap comprised between 0.8 and 1.2 mm and a thickness comprised between 0.6 and 1 mm.

44. Hymenoptera capture cage according to claim 30, wherein the distance between the large base and the small base of the funnel is comprised between 10 to 15 cm.

45. Hymenoptera capture cage according to claim 30, wherein the box comprises a removable cover.

46. Hymenoptera capture cage according to claim 30, wherein the two walls each comprise an opening in vis-à-vis.

47. Hymenoptera capture cage according to claim 30, configured so that the bottom comprises at least one porous portion, such as a screen plate, under which it is intended to position a bait.

48. Hymenoptera capture cage according to claim 30, wherein the porous plate comprises a flat portion of rectangular shape whose length is comprised between 11 and 20 cm and the width is comprised between 7 and 15 cm.

49. Kit for a hymenoptera capture cage according to claim 30 wherein said kit comprises:
a funnel for said capture cage, said funnel ending on its finest side by a base having at least one selective passage opening, wherein the opening passage comprises at least one limiting passage section of comprised between 7.0 and 9.0 mm, preferably 7.21 mm
a box having a bottom and at least three walls, preferably four walls, at least two walls of which each comprise an opening for attaching said funnel,
a lid.

50. Method for capturing at least one type of hymenoptera, preferably a hornet of the species Vespa velutina, wherein the hymenoptera capture cage according to claim 30 is calibrated for the effective passage of the thorax of a queen of said type of hymenoptera.

51. Method according to claim 50 wherein at least one bait is inserted into the capture cage, said at least one bait being optionally positioned and protected under a porous portion, such as a meshed portion.

52. Method according to claim 51 wherein said at least one bait is selected in the list consisting of honeyed waxes, red fruit syrup, dark beer, cider or sweet white wine saturated in sugars to which jam and/or honey can be added, or of meaty material, for example from fish, crustaceans or shellfish, or one of the mixtures thereof.

53. Method according to any one of claim 50 wherein islets constituted of small sponges are inserted as diffusers of olfactory scents in the capture cage.
